(19) United States
(12) Patent Application Publication
(10) Pub. No.: US 2002/0041199 A1
(43) Pub. Date: Apr. 11, 2002

(54) Electronic circuit

(76) Inventor: Bjorn Ekelund, Bjarred (SE)

Correspondence Address: JENKENS & GILCHRIST, PC, 1445 ROSS AVENUE, SUITE 3200, DALLAS, TX, 75202, US

(21) Appl. No.: 09/924,026

(22) Filed: Aug. 7, 2001

(30) Foreign Application Priority Data
Aug. 9, 2000 (GB) 0019617.0

(51) Int. Cl. H02J 1/00

(52) U.S. Cl. 327/530

(57) ABSTRACT

A controlling device, such as an ASIC, supplies a clock signal to a controlled device, for example in a mobile phone or other portable battery operated electronic equipment. The presence or absence of a clock signal controls the power supply to the controlled device. This avoids power consumption in analog as well as digital circuits, when in a standby state, while only using a single output pin on the controlling ASIC.

### TECHNICAL FIELD OF THE INVENTION

This invention relates to an electronic circuit, and in particular to a circuit which includes a controlling device and a controlled device. In particular, the invention relates to a circuit in which a controlled device can be powered down when inactive.

### BACKGROUND OF THE INVENTION

In battery-powered electronic devices, and in particular in portable hand-held battery-powered devices, in which the size and weight of the batteries and the available usage time of the device are important factors, it is necessary to minimize the power consumption.

One way in which this is achieved is to inactivate components of the device, during the periods when their use is not necessary. Typically, there is a controlling device, which includes a clock generation circuit. This supplies a clock signal, which determines the frequency at which a controlled device will operate. For example, a controlled device may include components which change state once in every cycle of the clock signal.

For some such devices, the static power consumption is zero. That is, if the clock signal to the controlled device is switched off, the device stops operating, and there is no power consumption.

However, other more complex devices typically include clocked components, which have no static power consumption as discussed above, and non-clocked components, which will continue to consume power even if there is no clock signal to the controlled device. In this case, power consumption can be reduced to zero by providing the power signal from the controlling device to the controlled device. Then, when it is determined that the controlled device is to be put into an inactive state, the clock signal can be stopped and the power supply can be disconnected at the same time. As a result, neither the clocked nor the unclocked components of the controlled device will consume power.

However, this requires the use of two output pins on the controlling device, one to supply the power signal to the controlled device, and one to supply the clock signal. In the case of a controlling device which controls the operation of a large number of controlled devices, this requires the use of a very considerable number of output pins in total. This in turn increases the size of the controlling device, which is disadvantageous in the case of devices which are to be used in portable hand-held electronic devices, where the general desire is to minimize the overall dimensions of the product.

### SUMMARY OF THE INVENTION

According to the present invention, a single output pin on a controlling device is used to supply a clock signal to a controlled device, and is also used to control the provision of a power supply to the controlled device.

In one preferred embodiment of the present invention, where the controlled device includes an input terminal which allows the controlled device to be powered down, the presence or absence of a clock signal is used to determine whether a signal is provided to that input of the controlled device.

In a second preferred embodiment of the present invention, when the controlled device has no input terminal which allows it to be powered down, the presence or absence of a clock signal is used to switch on or off the power supply.

Advantageously, a rectifier circuit is used to produce a DC signal from a clock signal, and the DC signal is used to control a power supply to a controlled device.

It should be emphasised that the term “comprises/comprising”, used herein, specifies the presence of stated features, but does not preclude the presence or addition of one or more further features.

### BRIEF DESCRIPTION OF DRAWINGS

FIG. 1 is a block schematic diagram of a first circuit in accordance with the present invention.

FIG. 2 shows the time histories of various signals within the circuit of FIG. 1.

FIG. 3 is a block schematic diagram of a second circuit in accordance with the present invention.

### DETAILED DESCRIPTION OF PREFERRED EMBODIMENTS

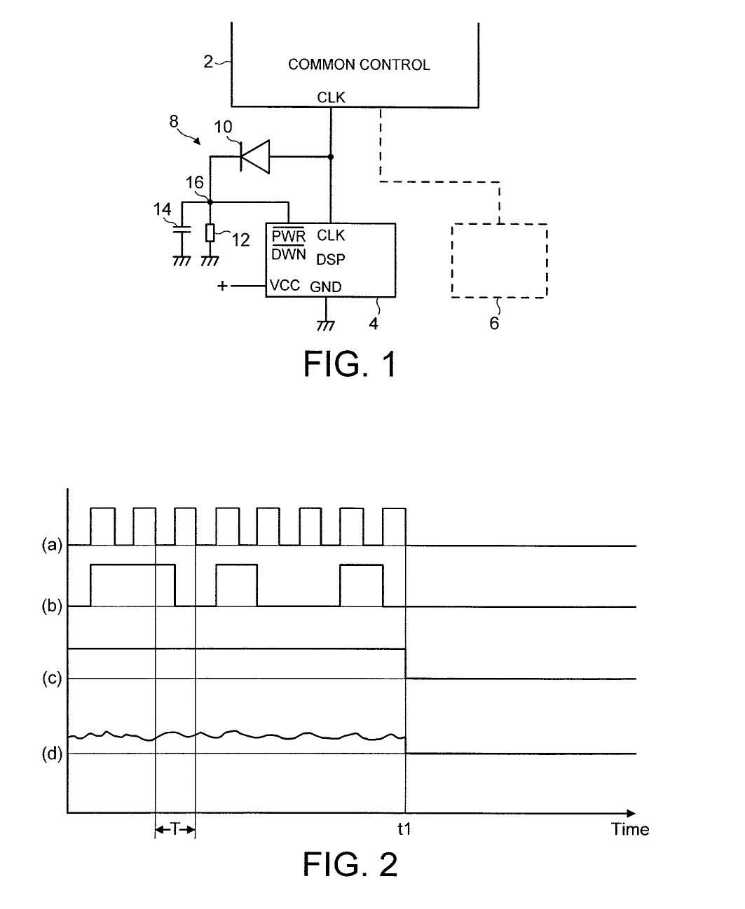

FIG. 1 shows a part of an electronic circuit in accordance with the invention. The circuit includes a common controlling element 2, which controls a number of controlled devices 4, 6, of which only two are shown in FIG. 1, and only one is shown in detail. However, it will be appreciated that there may be a large number of such controlled devices.

The electronic circuit advantageously forms part of a mobile radio terminal, for example a mobile phone, pager, communicator or electronic organiser.

The form of the common controlling device 2 is generally known to the person skilled in the art. It is an Application Specific Integrated Circuit (ASIC), designed to provide the required controlling functions, and includes circuits for generating a clock signal, and may include circuits for generating clock signals at different frequencies. One clock signal is provided on a clock output pin CLK. When the circuit forms part of a mobile phone or a handheld computer, for example, the common controlling device 2 typically contains the user interface functions and the central processing device. The user interface functions typically include the electronics for the display, the keyboard and possibly the sound. The central processing device typically controls the radio modem, switches on and off the light and sound, detects key presses, and shows information on the display.

The controlled device 4 is in this case a digital signal processor (DSP), although it may be, for example, an interface circuit (for example for a USB, IrDA or RS232C link, a smartcard, a display controller, a data converter, or a sound generator), or a radio circuit, such as a synthesizer, a mixer, or a clocked filter. Many common circuits operate as controlled devices as described.

The DSP 4 has a clock input pin CLK, a ground connection GND, and a power supply input terminal VCC.

The DSP 4 also has a power down input pin \overline{PWR} \overline{DWN}, which allows the device to be powered down. That is, when an input signal on the power down input terminal is high, the circuit operates at a clocking rate determined by the frequency of the clock signal supplied to the clock input CLK. However, when the signal on the power down input terminal is low, power is removed from all components of the device 4, and it goes into a power saving mode.

In accordance with the preferred embodiment of the invention, a signal which is supplied to the power down input terminal is generated from the clock signal which is supplied from the controlling device 2 to the controlled device 4.

Specifically, a rectifying circuit 8 is provided, comprising a diode 10, having its positive terminal connected to the clock output CLK of the controlling device 2, and a resistor 12 and capacitor 14, connected in parallel between the negative terminal of the diode 10 and ground.

Thus, the rectifying circuit 8 produces a rectified DC signal at a node 16, which is at a high level when there is a clock signal present. Thus, the clocked parts of the device operate at the rate set by the frequency of the clock signal, while a high level signal is provided to the power down input, and so the unclocked parts of the device also continue to operate. By contrast, when there is no clock signal supplied by the controlling device 2, the clocked parts of the controlled device 4 stop operating. Also, in that case, the rectifying device 8 cannot produce any signal level for the power down input of the controlled device 4 and, as a result, the unclocked parts of the device are powered down.

FIG. 2 shows the rectifying device separate from the controlled device 4. However, the rectifying device can be integrated with the controlled device, providing an output signal to a power down node within the controlled device.

FIG. 2 shows the time histories of various signals within the circuit of FIG. 1. Line (a) shows the clock signal output from the controlling device 2. As can be seen, this provides a clock signal, at a frequency f=1/T, until time t1, and thereafter is turned off. Line (b) shows a signal output by an exemplary digital latch device in the controlled device 4, being clocked at the frequency f. Line (c) shows the rectified signal at the node 16, and line (d) shows an analog signal on an exemplary analog component of the controlled device 4. In this illustrated example, where the controlled device 4 is a DSP, the signal illustrated in line (d) may be an audio signal, used to drive a loudspeaker.

Thus, the digital and analog components are all switched off, and power consumption of the controlled device can be reduced to zero, when it is in a standby mode.

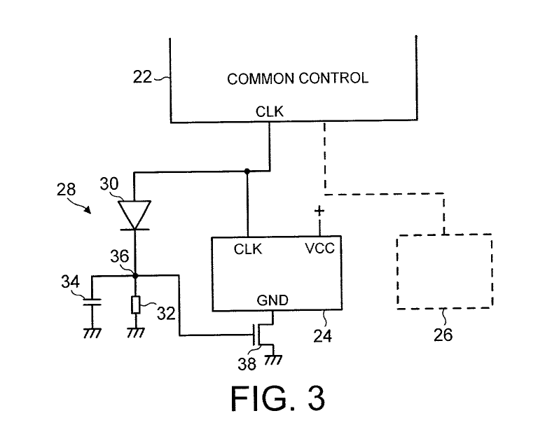

FIG. 3 shows a second circuit in accordance with the invention. A controlling device 22 provides a clock signal at a clock output pin CLK. A first controlled device 24 has a clock input terminal CLK, a power supply input terminal VCC and a ground connection terminal GND. FIG. 2 shows a second controlled device 26, although it will be appreciated that there can be any number of such controlled devices.

As in the embodiment of FIG. 1, the circuit includes a rectifying circuit 28, which includes a diode 30 having its positive terminal connected to the clock output pin CLK of the controlling device 22, and further includes a resistor 32 and capacitor 34, connected in parallel between the negative terminal of the diode 30 and ground.

In the presence of a clock signal output from the controlling device 22, the rectifying circuit 28 produces a rectified DC voltage at the node 36. The controlled device 24 is in this case, for example, a commercial pulse code modulation (PCM) coder/decoder device (codec), which contains clocked digital circuitry and unclocked analog circuitry. However, as is typical for this type of device, the codec 24 does not have an input power down terminal, and so will typically consume power at all times that the power supply input terminal VCC is connected to a power supply. As before, the controlled device could also be a digital signal processor (DSP), an interface circuit, or a radio circuit, for example, in this case without an input power down terminal.

In the presence of a clock signal on the clock output terminal CLK of the controlling device 22, the clocked digital circuitry of the controlled device 24 runs at a rate set by the frequency of the clock signal. Also, the rectified DC voltage at the node 36 is supplied to the gate of a MOS transistor 38, and switches it on, thereby making the connection from the ground terminal GND of the controlled device 24 to ground.

In the absence of a clock signal on the clock output terminal CLK of the controlling device 22, the clocked digital circuitry in the device 24 stops operating. At the same time, the rectified voltage at the node 36 falls to zero, and the transistor 38 turns off. Since the ground terminal GND of the controlled device 24 is no longer connected to the ground supply rail, the unclocked analog circuitry in the controlled device 24 can no longer consume power. The rectified control signal could equally be used to control the connection of the power supply input terminal to a positive power supply rail. As a result, the entire controlled device 24 is switched off, thereby minimizing its power consumption in a standby mode.

FIG. 3 shows the rectifying device separate from the controlled device 24. However, the rectifying device and associated circuitry such as the transistor 38, can be integrated with the controlled device, switching off the controlled device in the absence of the clock signal.

There is therefore disclosed a system which allows the minimization of the power consumption of a controlled device in a standby mode, even when the controlled device does not have a power down input terminal.

1. An electronic circuit, comprising a controlling device and a controlled device, the controlling device having a clock output terminal, and the circuit comprising a rectifier circuit, connected to receive a signal from the clock output terminal of the controlling device and to produce a control signal therefrom, the control signal controlling a power supply to the controlled device.

2. An electronic circuit as claimed in claim 1, characterised in that the control signal is applied to a power down input terminal of the controlled device.

3. An electronic circuit as claimed in claim 1, characterised in that the control signal is used to control the connection of the power supply to the controlled device.

4. An electronic circuit as claimed in claim 1, wherein the rectifier circuit is integrated with the controlled device.

5. An electronic circuit, comprising a controlling device and a controlled device, characterised in that a single output pin on the controlling device is used to supply a clock signal to the controlled device, and is also used to control a power supply to the controlled device.

6. An electronic circuit as claimed in claim 5, wherein the controlled device includes an input terminal which allows the device to be powered down, characterised in that the presence or absence of a clock signal on said output pin is used to determine whether a signal is supplied to said input terminal of the controlled device.

7. An electronic circuit as claimed in claim 5, wherein the controlled device does not include an input terminal which allows the device to be powered down, characterised in that the presence or absence of a clock signal on said output pin is used to connect or disconnect the power supply to the controlled device.

8. A mobile radio terminal, characterised in that it includes an electronic circuit according to any of claims 1-7.

9. A mobile phone, characterised in that it includes an electronic circuit according to any of claims 1-7.

10. A method of controlling a controlled device in an electronic circuit, the method comprising:
detecting a clock signal supplied to the controlled device;
rectifying the clock signal to form a control signal; and
using the control signal to control a power supply to the controlled device.

11. A method as claimed in claim 10, wherein the control signal is supplied to a power down input terminal of the controlled device.

12. A method as claimed in claim 10, wherein the control signal controls the connection of the controlled device to a voltage supply rail.

13. A method as claimed in claim 10, comprising rectifying the clock signal in the controlled device.
